(19) United States
(12) Patent Application Publication
(10) Pub. No.: US 2025/0016862 A1
(43) Pub. Date: Jan. 9, 2025

(54) PACKET TRANSMISSION DEVICE, PACKET TRANSMISSION METHOD, AND STORAGE MEDIUM

(71) Applicant: DENSO CORPORATION, Kariya-city (JP)

(72) Inventor: Naoki IWATA, Kariya-city (JP)

(21) Appl. No.: 18/890,585

(22) Filed: Sep. 19, 2024

Related U.S. Application Data
(63) Continuation of application No. PCT/JP2022/047982, filed on Dec. 26, 2022.

(30) Foreign Application Priority Data
Mar. 23, 2022 (JP) 2022-046419

(51) Int. Cl. H04W 76/15; H04L 5/00; H04W 28/06

(52) U.S. Cl. CPC H04W 76/15; H04L 5/0048; H04W 28/06

(57) ABSTRACT

A packet transmission device transmits data packets to a packet receiving device using a first communication link and a second communication link with a smaller communication area than the first communication link. The device determines the communication status of the second communication link, sets either one of the first or second communication link as a main communication link and the other as a sub communication link, based on the determination results, generates instructions to transmit main data packets on the main communication link and sub data packets with bandwidth limitation on the sub communication link, transmit the main data packets or the sub data packets via the first communication link based on the instructions, and transmits the sub data packets or the main data packets via the second communication link based on the instructions.

### CROSS-REFERENCE TO RELATED APPLICATION

The present application is a continuation application of International Application No. PCT/JP2022/047982, filed on Dec. 26, 2022, which claims priority to Japanese Patent Application No. 2022-046419, filed on Mar. 23, 2022. The contents of these applications are incorporated herein by reference in their entirety.

### BACKGROUND

### 1. Technical Field

This disclosure relates to a packet transmission device, a packet transmission method, and a storage medium.

### 2. Related Art

In recent years, there has been some consideration of coordinating several different types of wireless communications to communicate in parallel.

### SUMMARY

A packet transmission device according to an aspect of the present disclosure is a packet transmission device that transmits data packets to a packet receiving device using a first communication link and a second communication link, the second communication link having a smaller communication area than the first communication link. The packet transmission device has: a packet storage that stores the data packets, a communication status determination unit that determines the communication status of the second communication link, a main and sub link setting unit that sets either the first or second communication link as a main communication link and the other as a sub communication link based on the results of the determination by the communication status determination unit, a packet generation unit that generates main data packets without bandwidth limitation and sub data packets with bandwidth limitation from the data packets, a transmission instruction unit that instructs each of the first communication unit and the second communication unit to transmit the main data packets via the main communication link or transmit the sub data packets via the sub communication link, the first communication unit that transmits the main data packets or the sub data packets via the first communication link according to the instruction from the transmission instruction unit, and the second communication unit that transmits the main data packets or the sub data packets via the second communication link according to the instruction from the transmission instruction unit.

The packet transmission method according to another aspect of the present disclosure is a packet transmission method using a packet transmission device that transmits data packets to a packet receiving device using a first communication link and a second communication link, the second communication link having a smaller communication area than the first communication link. The packet transmission method includes: determining the communication status of the second communication link, setting either the first communication link or the second communication link as a main communication link and the other as a sub communication link based on the result of the determination of the communication status, generating main data packets without bandwidth limitation and sub data packets with bandwidth limitation from the data packets stored in the packet storage, generating instructions to transmit the main data packets on the main communication link and the sub data packets on the sub communication link, transmitting the main data packets or the sub data packets using the first communication link according to the instructions, and transmitting the sub data packets or the main data packets using the second communication link according to the instructions.

The storage medium according to other aspects of the present disclosure is a computer-readable non-transitory storage medium. The storage medium stores a packet transmission program. The packet transmission program causes a packet transmitting device that transmits data packets to a packet receiving device using a first communication link and a second communication link, the second communication link having a smaller communication area than the first communication link, to, determine a communication status of the second communication link, set either the first communication link or the second communication link as a main communication link and the other as a sub communication link based on the result of the determination of the communication status, generate main data packets without bandwidth limitation and sub data packets with bandwidth limitation from the data packets stored in the packet storage, generate instructions for transmitting the main data packets on the main communication link, transmit the main data packets or the sub data packets using the first communication link according to the instructions, and transmit the main data packets or the sub data packets using the second communication link according to the instructions.

### BRIEF DESCRIPTION OF THE DRAWINGS

In the accompanying drawings:

FIG. 1 is an illustration of the communication system and a schematic of this system;

FIG. 2 shows the configuration of this packet transmission device;

FIG. 3 illustrates the data structure of data packets and main/sub data packets in this system;

FIG. 4 illustrates one packet in each of the main data packets and the sub data packets;

FIG. 5 illustrates the data structure of the Ack packet;

FIG. 6 shows the main flowchart of the operation of the packet transmission device.

FIG. 7 illustrates the reception situation of the Ack packets for this smaller-area communication link;

FIG. 8 is a flowchart showing the method of determining the communication status of a smaller-area communication link;

FIG. 9 illustrates the reception status of Ack packets for larger-area and smaller-area communication links in this system;

FIG. 10 is a flowchart showing how the main and sub communication links are set up;

FIG. 11 is a flowchart showing how the main data packets and sub-data packets is generated in this system;

FIG. 12 is a flowchart showing the method of indicating the transmission of main data packets and sub-data packets in this system; and

FIG. 13 shows the configuration of the packet receiving device 20.

### DETAILED DESCRIPTION OF THE PREFERRED EMBODIMENTS

JP2015-173494A discloses a technique of transmitting data using multiple modems with different communication performance characteristics and having the associated modems transmit packets according to the optimal rate under the real-time prevailing conditions. This technique allows for virtual high-bandwidth communication.

After detailed study, the inventors of this application found the following issue. JP2015-173494A discloses a technique for distributing communication load. In this technique, many packets are allocated to broadband communication links. However, when the broadband communication link is disconnected, packet loss occurs for the large number of allocated packets. Usually, packet loss is recovered using error correction techniques such as FEC. However, error correction techniques may not be able to handle a large amount of packet loss, so packet retransmission may be necessary. Especially for in-vehicle applications, since the communication environment may change drastically in time or space, packet retransmissions are assumed to occur frequently.

The purpose of this disclosure is to suppress the occurrence of packet loss and prevent frequent packet retransmissions in technologies that use multiple communication links.

The packet transmission device of the present disclosure can suppress the occurrence of packet loss and prevent frequent packet retransmissions.

Embodiments of the present disclosure are described below with reference to the drawings.

The present invention means the invention described in the claims and is not limited to the following embodiments. Words and phrases in double quotation marks refer to the words and phrases described in the claims, and likewise are not limited to the following embodiments.

The configurations and methods described in the dependent claims are optional configurations and methods of the invention described in the independent claims. Configurations and methods of embodiments corresponding to the configurations and methods described in the dependent claims, as well as configurations and methods not described in the claims but only in the embodiments, are optional configurations and methods of the present invention. The configurations and methods described in the embodiments in cases where the claims are broader than the description of the embodiments are also optional configurations and methods in the present invention in the sense that they are examples of the configurations and methods of the invention. In either case, the description in the independent claims is an essential configuration and method of the invention.

The effects described in the embodiments are those of having the configuration of the embodiments as an example of the invention and not necessarily those of the invention.

If there are multiple embodiments (including variations), the configuration disclosed in each embodiment is not limited to the embodiment only but can be combined across embodiments. For example, the configuration disclosed in one embodiment can be combined with other embodiments. Also, configurations disclosed in each of multiple embodiments can be partially collected and combined.

The problems described in this disclosure are not publicly known but were independently discovered by the inventor. The problems described in this disclosure affirms the inventive step of the invention together with the composition and method described in this disclosure.

### 1. Embodiment

(1) Outline of this Communication System and this System

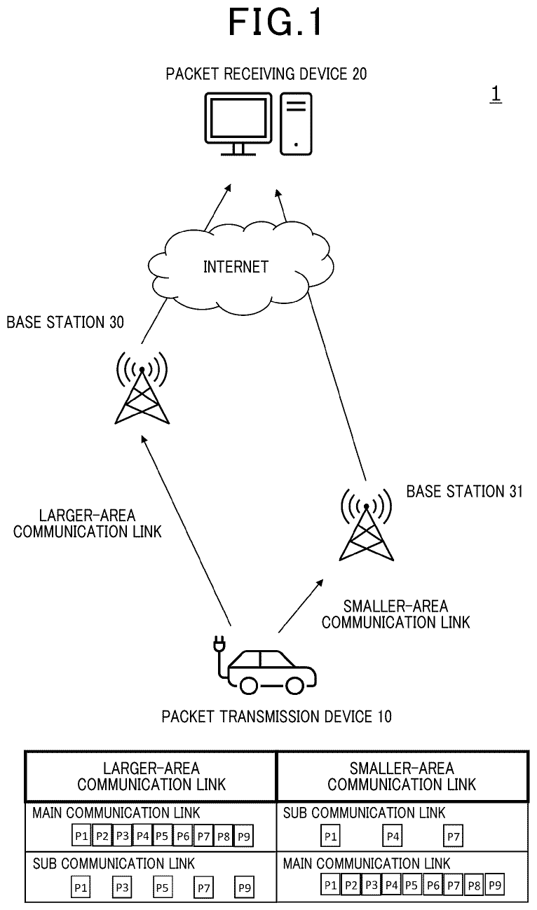

FIG. 1 shows an example configuration of a communication system 1 including a packet transmission device 10.

For example, the communication system 1 may include the packet transmission device 10, a packet receiving device 20, a larger-area communication link, and a smaller-area communication link. The larger-area communication link includes a base station 30, and the smaller-area communication link includes a base station 31.

The communication coverage area of the larger-area communication link (an example of the “first communication link”) is larger than that of the smaller-area communication link (an example of the “second communication link”. For example, the communication coverage area is the coverage area per one base station. Since the communication coverage area of the larger-area communication link is wider than that of smaller-area communication links, the possibility of communication disconnection due to movement is lower for larger-area communication links than for smaller-area communication links. Examples of the larger-area communication links are W-CDMA (Wideband Code Division Multiple Access), HSPA (High Speed Packet Access), LTE (Long Term Evolution), LTE A (Long Term Evolution Advanced), 4G (4th Generation Mobile Communication System), and standalone (SA) 5G (5th Generation Mobile Communication System).

When 4G is used as the larger-area communication link, the radius of the communication area of the larger-area communication link is a dozen kilometers when a macro cell is used. The communication speed of the uplink from packet transmission device 10 to base station 30 is about 100 Mbps at maximum.

Since the communication area of the smaller-area communication link is smaller than that of the larger-area communication link, the possibility of communication disconnection due to movement is higher for the smaller-area communication link than for the larger-area communication link. Usually, the communication speed of the smaller-area communication link is faster than that of the larger-area communication link, and the throughput of a smaller-area communication link is better than that of the larger-area communication link. Examples of the smaller-area communication links include the non-standalone (NSA) 5G (5th Generation Mobile Communication System), IEEE802.11 (Wi-Fi (registered trademark)), or IEEE802.16 (WiMAX (registered trademark)).

When non-standalone 5G is used as the smaller-area communication link, the radius of the communication area of the smaller-area communication link is at most a few hundred meters in radius, even in areas with good visibility, when small cells are used. The communication speed of the uplink link from packet transmission device 10 to base station 31 is up to 10 Gbps, which is much faster than 4G.

The relationship regarding the breadth of the larger-area communication link and the smaller-area communication link may be relative and is not limied to the above examples. The relationship regarding the breadth of the communication area may be defined by considering cell size, transmit power, or carrier frequency, as well as beamforming and directivity. If these communication links are wireless communication links, other examples of communication links include Bluetooth (registered trademark), UWB (Ultra-Wide Band), or DSRC (Dedicated Short-Range Communication).

The type of communication between the base station 30 and the packet receiving device 20 and between the base station 31 and the packet receiving device 20 can be any type. Communications between the base station 30 and the packet receiving device 20 and between the base station 31 and the packet receiving device 20 are performed, for example, using the backbone links of telecommunication carriers, the Internet, and LANs for premises connection. In addition, wireless and wired communication links may be mixed in the communication links that mediate this communication. One of or both the larger-area communication link and the smaller-area communication link may be wireless communication paths that directly connect the packet transmission device 10 and the packet receiving device 20, without going through the base station 30 or the base station 31.

The packet transmission device 10 sends “data packets” to the packet receiving device 20 using the larger-area communication links and the smaller-area communication links. “Data packets” are units of data for communication, and their size may be of variable or fixed length. For example, if data packets are TCP segments, the data packets are variable length packets of up to 1460 bytes. The name of the data packets is arbitrary. For example, it may be referred to as a frame, subframe, subblock, etc., in addition to a packet.

The packet transmission device 10 sets either the larger-area communication link or the smaller-area communication link as a main communication link and the other as a sub communication link. When transmitting packets via the main communication link, the packet transmission device 10 transmits packets without thinning them out, and when transmitting packets via the sub communication link, the packet transmission device 10 transmits packets with thinning out. For example, in FIG. 1, when the packet transmission device 10 sets the larger-area communication link as the main communication link and sets the smaller-area communication link as the sub communication link, it transmits all packets P1 to P9 via the larger-area communication link and transmits packets P1, P4, and P7 via the smaller-area communication link. On the other hand, when the packet transmission device 10 sets the larger-area communication link as the sub communication link and sets the smaller-area communication link as the main communication link, it transmits packets P1, P3, P5, P7, and P9 via the larger-area communication link and transmits all packets P1 to P9 via the smaller-area communication link.

The packet receiving device 20 receives the data packets from the packet transmission device 10 and sends an Ack packet to the packet transmission device 10 as an acknowledgement. The Ack packet may be sent via either the smaller-area communication link or the larger-area communication link.

The packet transmission device 10 is “mounted” to a “mobile object” in the case of this implementation. The packet transmission device 10 may be mounted to a fixed object instead of the mobile object. The packet receiving device 20 is, for example, but not limited to, a server device in a data center. The packet receiving device 20 may be mounted to the “mobile object. The “mobile object” is an object that can move, and the speed at which it moves is arbitrary. It also includes, of course, the case where the mobile object is stationary. Examples of the mobile object include, but are not limited to, automobiles, motorcycles, bicycles, pedestrians, ships, aircraft, and their mountings. The term “mounted” includes cases where the device is directly fixed to the mobile object as well as cases where the device is not fixed to a mobile object but moves with the mobile object. For example, it may be carried by a person on the mobile object, or it may be mounted to a load placed on the mobile object.

### (2) Configuration of Packet Transmission Device 10

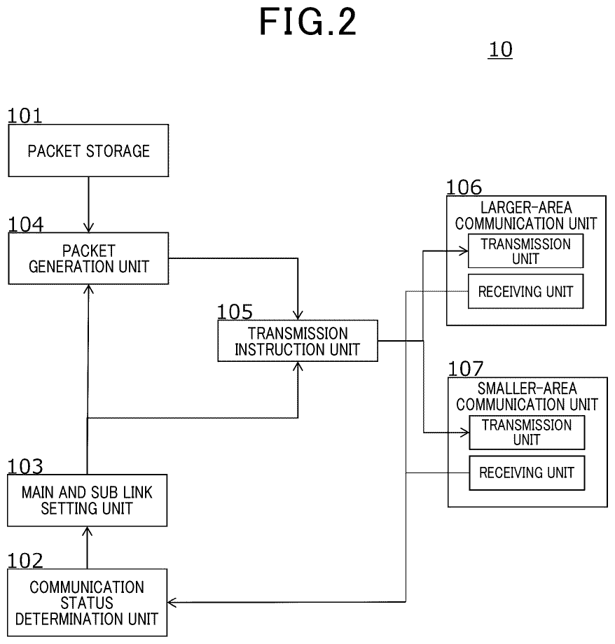

FIG. 2 shows the configuration of the packet transmission devices 10. The packet transmission device 10 may include, for example, a packet storage 101, a communication status determination unit 102, a main and sub link setting unit 103, a packet generation unit 104, a transmission instruction unit 105, a larger-area communication unit 106, and a smaller-area communication unit 107. The larger-area communication unit 106 transmits and receives data including the data packets using the larger-area communication links, and the smaller-area communication unit 107 transmits and receives data including the data packets using the smaller-area communication links.

The packet storage 101 stores the data packets to be sent to the packet receiving device 20. Packet storage 101 is a read/write storage medium. Packet storage 101 is realized, for example, in RAM, various semiconductor memories, hard disks, and the like. Packet storage 101 can be either nonvolatile memory or volatile memory.

The communication status determination unit 102 determines the communication status of the smaller-area communication link. The communication status determination unit 102 determines whether the communication status of the smaller-area communication link is good or poor based on a reception condition (reception status) of the Ack packet, which is an acknowledgement of the data packets transmitted over the smaller-area communication link. The specific determination method by the communication status determination unit 102 is explained along with the operation of the packet transmission device 10, and specific examples of Ack packets are explained along with the details of the processing of the larger-area communication unit 106 and the smaller-area communication unit 107.

The main and sub link setting unit 103 sets either one of the larger-area or smaller-area communication links as the main communication link and the other as the sub communication link based on the result of the determination by the communication status determination unit 102. The specific setting method by the main and sub link setting unit 103 is explained along with the operation of the packet transmission device 10.

The packet generation unit 104 generates the main data packets without “bandwidth limitation“and the sub data packets with” bandwidth limitation” from the data packets stored in the packet storage 101. In this implementation, the bandwidth limitation is policing, which is the process of thinning out the data packets in packet units within a specified bandwidth. “Bandwidth limitation” refers to the process of reducing the amount of data transmission per unit of time, and may include policing, in which a portion of the data packets are discarded, as well as shaping, in which the data packets is stored in a buffer and the transmission time is delayed.

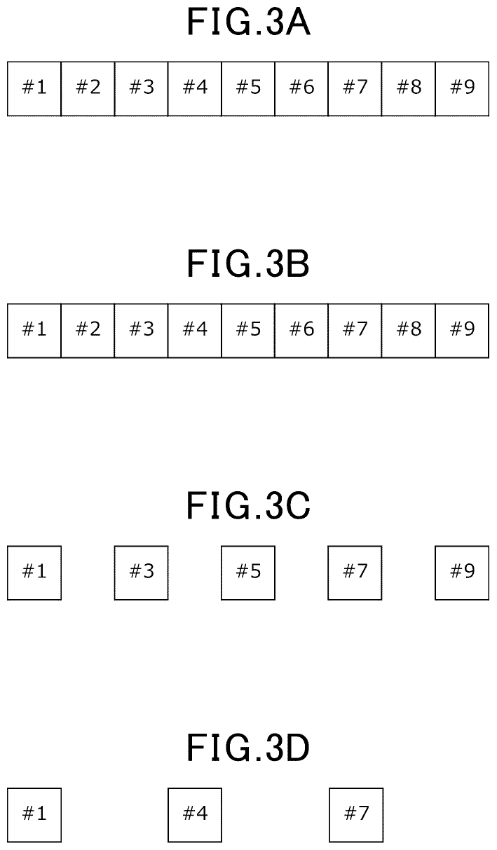

FIG. 3 shows the data packets and the main data packets and the sub data packets generated from the data packets. In the following description, the data packets basically mean a set of individual packets, but an individual packet may be interpreted as the data packets. FIG. 3A shows the data packets stored in packet storage 101. In FIG. 3A, the data packets consist of 9 packets from #1 to #9,and these packets are stored in the order in which they are to be transmitted over the main communication link. The number attached to # is a sequence number and indicates the order of transmission without considering retransmission. FIG. 3B shows the main data packets. Since the main data packets are not subject to bandwidth limitation, the main data packets contain all packets from #1 to #9. The main data packets have the same packet structure whether they are transmitted over the larger-area communication link or the smaller-area communication link.

FIG. 3C shows the sub data packets transmitted via the larger-area communication link. Since the sub data packets is policed, the packets are thinned out from the sub data packets. In FIG. 3C, the sub data packets contain packets #1, #3, #5, #7, and #9, and packets #2, #4, #6, and #8 are thinned out. Policing when the sub data packets is transmitted via the larger-area communication links should be performed over a relatively wide bandwidth of about 10 Mbps, for example. The degree of policing may be fixed or variable. Policing should be performed to a degree that congestion does not occur, based on information obtained by monitoring the communication status of the larger-area communication link. Packets to be thinned out by policing may be randomly selected, or specific packets selected by any criteria may be thinned out. For example, when the packet size of a packet is variable, packets with a packet size larger than a predetermined size may be thinned out.

FIG. 3D shows the sub data packets transmitted via the smaller-area communication link. Since the sub data packets are policed, the packets are thinned out in the sub data packets. In FIG. 3D, the sub data packets contain packets #1, #4, and #7, and packets #2, #3, #5, #6, #8, and #9 are thinned out. In this way, policing is performed so that the degree of thinning is greater when the smaller-area communication link is the sub communication link than when the larger-area communication link is the sub communication link. Which link the sub data packets are transmitted on, i.e., for which link the sub data packets are generated, is determined based on the settings of the main and sub link setting unit 103. Policing when the sub-data packets is transmitted over the smaller-area communication links should be performed over a relatively narrow-bandwidth of about 1 Mbps or 128 Kbps, for example. The degree of policing may be fixed or variable. The packets to be thinned by policing may be randomly selected, or specific packets selected by any criteria may be thinned. For example, when the packet size of a packet is variable, packets with a packet size larger than a predetermined size may be thinned out.

By receiving the settings of the main and sub link setting unit 103, the packet generation unit 104 determines which policing is to be performed: policing when the sub data packets are transmitted on the larger-area communication link or policing when the sub data packets are transmitted on the smaller-area communication link. Without receiving the settings of the main and sub link setting unit 103, the packet generation unit 104 may generate the both sub data packets with policing for the case where the sub data packets are transmitted via the larger-area communication link and the sub data packets with policing for the case where the sub data packets is transmitted via the smaller-area communication link.

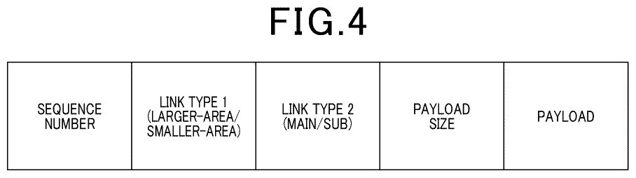

FIG. 4 shows one packet in each of the main data packets and the sub data packets. Each packet contains, for example, a sequence number, link type 1, link type 2, payload size, and payload. The link type 1 indicates whether the packet is transmitted over the larger-area communication link or the smaller-area communication link. The link type 2 indicates whether the data is transmitted via the main communication link or the sub communication link. Link type 1 and link type 2 are set by the main and sub link setting unit 103.

The transmission instruction unit 105 instructs each of the larger-area communication unit 106 and the smaller-area communication unit 107 to transmit the main data packets via the main communication link or to transmit the sub data packets via the sub communication link. The transmission instruction unit 105 instructs the larger-area communication unit 106 and the smaller-area communication unit 107 which of the larger-area communication unit 106 and the smaller-area communication unit 107 will perform processing for the main communication link, and which will perform processing for the sub communication link, based on the results set by the main and sub communication link setting unit 103. In other word, the transmission instruction unit 105 instructs the larger-area communication unit 106 and the smaller-area communication unit 107 which of the larger-area communication unit 106 and the smaller-area communication unit 107 will transmit the main data packets and which will transmit the sub data packets.

A transmission unit of the larger-area communication unit 106 transmits the main data packets when the larger-area communication link is set as the main communication link and transmits the sub data packets when the larger-area communication link is set as the sub communication link, according to the instructions from the transmission instruction unit 105. The larger-area communication unit 106 is an example of a “first communication unit”. A transmission unit of the smaller-area communication unit 107 transmits the main data packets when the smaller-area communication link is set as the main communication link and transmits the sub data packets when the smaller-area communication link is set as the sub communication link, according to the instructions from the transmission instruction unit 105. When the smaller-area communication link is set as the sub communication link and the communication status of the smaller-area communication link is poor, the smaller-area communication unit 107 can only output a transmission command, not actually transmit the sub data packets. However, in this embodiment, outputting a transmission command is included in the meaning of “transmitting”. The packet transmission device 10 transmits the main data packets and the sub data packets, and the main data packets contains all the packets that make up the data packets. Therefore, the transmission target of packet transmission device 10 includes the data packets.

For example, each of a receiving unit of the larger-area communication unit 106 and a receiving unit of the smaller-area communication unit 107 may receive the Ack packets, which are confirmation responses to packets sent by each of the larger-area communication unit 106 and the smaller-area communication unit 107, from the packet receiving device 20.

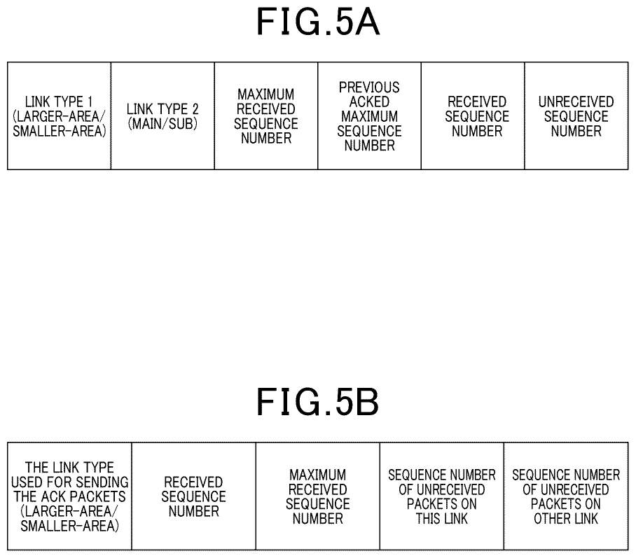

FIG. 5A shows an example of the Ack packet. Each of the link type 1 and link type 2 indicates the type of link on which the packet that triggers the generation of the Ack packet was sent, and are the same information shown in FIG. 4. The maximum received sequence number is the largest sequence number of packets that have been received by the packet receiving device 20. The previous Acked Maximum Sequence Number is the maximum sequence number received by the packet receiving device 20 the last time the packet receiving device 20 sent the Ack packet. The received sequence number is the sequence number of the packet that triggered the generation of this Ack packet. When the packet receiving device 20 has received packets in sequence number order, the received maximum sequence number and the received sequence number should be the same, but they may not be the same due to link delay or other factors. The unreceived sequence number is the sequence number of a packet that has not yet been received by the packet receiving device 20. If there are multiple packets that have not been received, multiple sequence numbers are stored in the unreceived sequence number. For example, in a case that the packet receiving device 20 has received packets #1, #3, #4, #5, and #9, the Ack packet sent when packet #9 is received contains #9 as the received maximum sequence number, #5 as the previous Acked maximum sequence number, #9 as the received sequence number, and #2, #6, #7, and #8 as the unreceived sequence numbers.

In this system, each of the Ack packets for the larger-area communication link and the Ack packets for the smaller-area communication link store the packet reception status of each link, but the Ack packet may store together with the reception status of the larger-area communication link and the smaller-area communication link.

FIG. 5B shows another example of the Ack packet. As shown in FIG. 5B, the Ack packet may contain the following information: the link type used for sending the Ack packets (i.e., the larger-area communication link or the smaller-area communication link?), the received sequence number, the maximum received sequence number, the main link unreceived sequence number indicating the sequence number of unreceived packets on the link transmitting the Ack packet, the sequence number of unreceived packets on a different link than the link transmitting the Ack packet, and other information as shown in FIG. 5B. The link unreceived sequence number may be stored in the Ack packet.

### (3) Operation of Packet Transmission Device 10

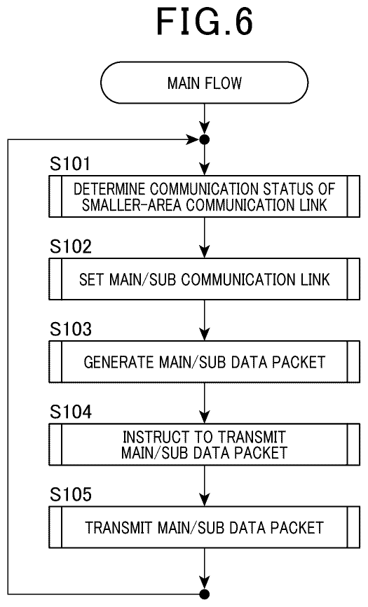

The operation of the packet transmission device 10 is described referring FIGS. 6 through 12. The operations described below not only show the packet transmission method in packet transmission device 10, but also the processing steps of the packet transmission program executed in packet transmission device 10. And these operations or processes are not limited to the order shown in FIGS. 6 through 12. For example, the order may be interchanged if there are no restrictions, such as a relationship in which one step uses the results of the preceding step. The above description applies not only to this form, but also to other forms and variations.

### (a) Main Flow (Main Routine)

FIG. 6 shows the main flow of the operation of the packet transmission device 10.

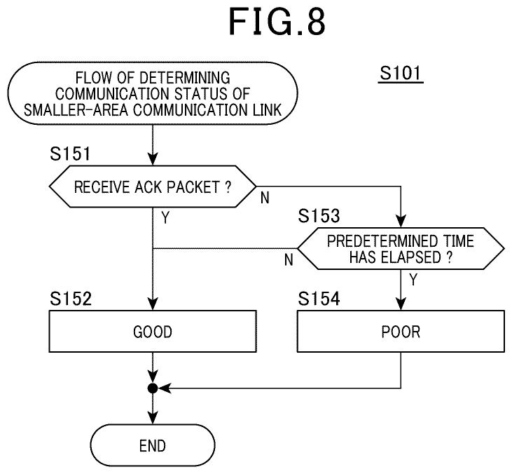

The communication status determination unit 102 determines the communication status of the smaller-area communication link (S101). Specifically, the communication status determination unit 102 determines whether the communication status of the smaller-area communication link is good or poor based on the Ack packets received at the receiving unit of the smaller-area communication unit 107. The details of the S101 process are described below using FIG. 8.

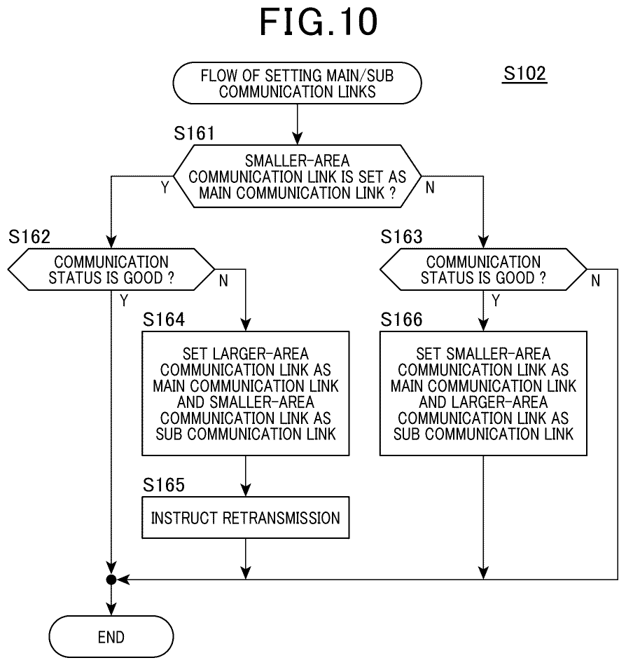

Based on the result of the determination in S101, the main and sub link setting unit 103 sets either one of the larger-area communication link or the smaller-area communication link as the main communication link and the other as the sub communication link (S102). The details of the processing in S102 are described later using FIG. 10.

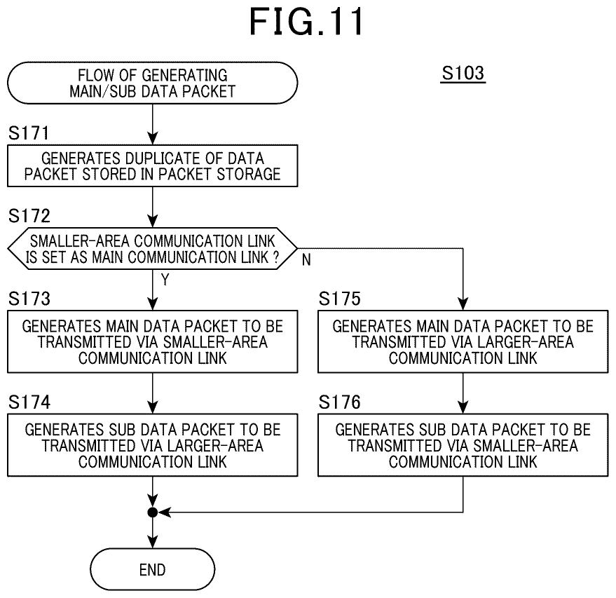

The packet generation unit 104 generates the main data packets without “bandwidth limitation“and the sub data packets with” bandwidth limitation” from the data packets stored in the packet storage 101 (S103). The details of the processing in S103 are described later using FIG. 11.

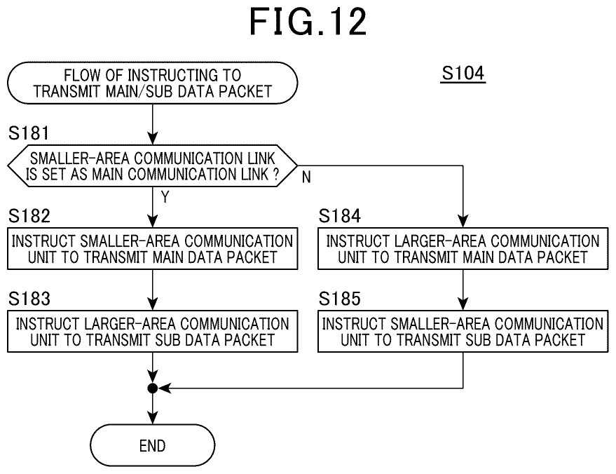

Transmission instruction unit 105 instructs each of the larger-area communication unit 106 and the smaller-area communication unit 107 to transmit the main data packets generated by the packet generation unit 104 on the main communication link or transmit the sub data packets on the sub communication link (S104). The details of the processing in S104 are described below using FIG. 12.

Based on the instructions generated in S104, the larger-area communication unit 106 transmits the main data packets or the sub data packets via the larger-area communication link, and the smaller-area communication unit 107 transmits the sub data packets or the main data packets via the second communication link (S105).

The above process is repeated each time the data packets containing a predetermined number of packets are stored in the packet storage 101.

### (b) Determination of the Communication Status of the Smaller-Area Communication Link (Subroutine of S101)

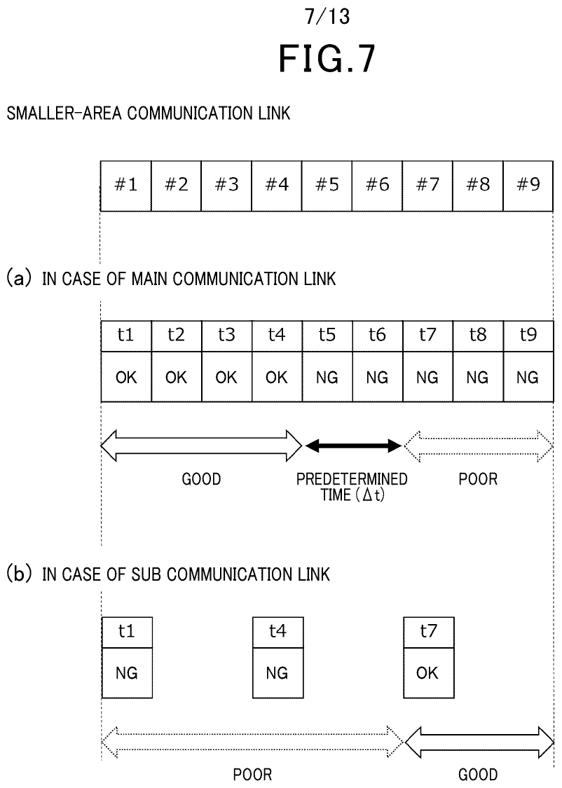

FIGS. 7 and 8 are referred to explain how to determine the communication status of smaller-area communication links.

FIG. 7 shows the reception situation of the Ack packets for the smaller-area communication links. When the smaller-area communication link is set as the main communication link, the transmission unit of the smaller-area communication unit 107 transmits main data packets without policing, and the receiver of the smaller-area communication unit 107 receives the Ack packets for the packets transmitted by the transmission unit from the packet receiving device 20. In the figure, “OK” indicates that the Ack packet was received, and “NG” indicates that the Ack packet was not received.

When the communication status determination unit 102 receives the Ack packet, the communication status determination unit 102 determines that the communication status is good. On the other hand, when the communication status determination unit 102 does not receive the Ack packet for a predetermined time (Δt), it determines that the communication status is poor. The start timing for measuring the predetermined time is, for example, when the packet was sent. Until the state in which no packet is received for the predetermined time elapses, the communication status judging unit 102 suspends determination. In FIG. 7, when the predetermined time (Δt) has elapsed since t5, the time when #5 was sent, the communication status is determined to be poor. The reason for waiting for the elapse of the predetermined time to determine that the communication status is poor is to exclude cases where a communication delay of an acceptable degree has occurred.

The communication status determination unit 102 may determine that the communication status is poor when a predetermined number of Ack packets are not received, instead of using the predetermined time (Δt). In this case, in FIG. 7, the communication status determination unit 102 determines that the communication status is poor when Ack packets for the two packets #5 and #6 have not been received. The reason for determining that the communication status is poor when a predetermined number of Ack packets are not received is to exclude cases where the communication status has no problem but is due to packet loss.

When the smaller-area communication link is set as the sub communication link, the transmission unit of the smaller-area communication unit 107 transmits the sub data packets that are policed, and the receiver of the smaller-area communication unit 107 receives the Ack packets for the packets transmitted by the transmission unit from the packet receiving device 20.

The communication status determination unit 102 determines that the communication status is good when the Ack packet is received and determines that the communication status is poor when none of the Ack packets are received for the predetermined time (Δt). In FIG. 7, the communication status is determined to be good when the Ack packet for #7 is received.

FIG. 8 shows the flow of determining the communication status of the smaller-area communication link. The communication status determination unit 102 determines whether the Ack packet for the packet sent from the transmission unit of the smaller-area communication unit 107 is received from the packet receiving device 20 (S151). In a case that it has been received, the communication status determination unit 102 proceeds to S152; if not, it proceeds to S153.

In a case that the Ack packet is received, the communication status determination unit 102 determines that the communication status of the smaller-area communication link is good (S152).

In a case that none of the Ack packets are received, the communication status determination unit 102 determines whether the predetermined time has elapsed since the most recent packet was sent (S153). When the predetermined time has not elapsed, the communication status determination unit 102 proceeds to S152, and when the predetermined time has elapsed, it proceeds to S154.

When the predetermined time has elapsed, the communication status determination unit 102 determines that the communication status of the smaller-area communication link is poor (S154).

### (c) Setting of the Main and Sub Communication Links (Subroutine S102)

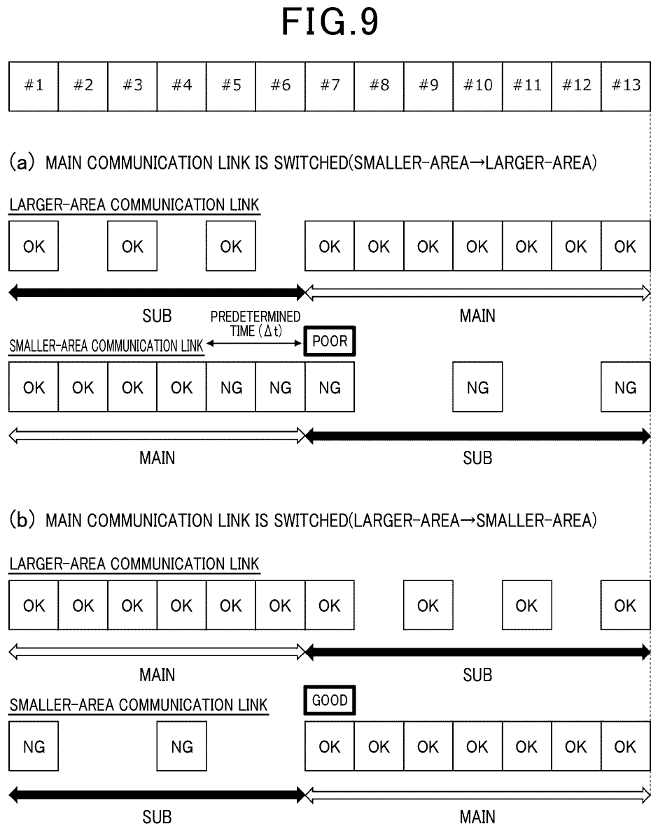

FIGS. 9 and 10 illustrate how the main and sub communication links are set up.

FIG. 9 shows the reception status of the Ack packets for the larger-area communication link and the smaller-area communication link. The upper figure in FIG. 9 shows how the larger-area communication link is switched to the main communication link and the smaller-area communication link is switched to the sub communication link, from the state where the smaller-area communication link is set as the main communication link and the larger-area communication link is set as the sub communication link. Initially, since the smaller-area communication link is set as the main communication link, the transmission unit of the smaller-area communication unit 107 transmits the main data packets that are not policed. Since the larger-area communication link is set as the sub communication link, the transmission unit of the larger-area communication unit 106 transmits the sub data packets with policing. In this case, since both the smaller-area communication link and the larger-area communication link can communicate, both the receiving unit of the larger-area communication unit 106 and the smaller-area communication unit 107 receive the Ack packets for the data packets sent from each transmitting unit.

When the receiving unit of the smaller-area communication unit 107 does not receive the #5 and #6 Ack packets, the communication status determination unit 102 determines that the communication status of the smaller-area communication link is poor. In response, the main and sub link setting unit 103 sets the larger-area communication link as the main communication link and the smaller-area communication link as the sub communication link (in other words, switches the setting). After switching the setting, the transmitting unit of the smaller-area communication unit 107 transmits the sub data packets with policing but does not receive any Ack packets because the communication status is poor. On the other hand, the transmission unit of the larger-area communication unit 106 transmits the main data packets without policing and receives the Ack packets.

The degree to which packets are thinned out is greater for policing when the smaller-area communication link is set as the sub communication link compared to policing when the larger-area communication link is set as the sub communication link. This is because when the smaller-area communication link is set as the sub communication link, the packets transmitted are less likely to reach the packet receiving device 20 because the communication status is determined to be poor. Furthermore, this is because in this case, packet transmission on the smaller-area communication link is mainly performed to detect when the communication status of the smaller-area communication link has changed to be good. By transmitting the sub data packets with policing when the smaller-area communication link is set as the sub communication link, a resource request for data bandwidth reservation in the smaller-area communication link is periodically made. As a result, it is possible to quickly detect when the packet transmission device 10 has entered the range where the smaller-area communication link can be used. As a result, the packet transmission device 10 can more quickly connect to the smaller-area communication links, which generally have sufficient communication speed and capacity.

When the communication status determination unit 102 determines that the communication status of the smaller-area communication link, which is set as the main communication link, is poor, the transmission instruction unit 105 may instruct the transmission unit of the larger-area communication unit 106, which communicates via the larger-area communication link that has been switched to the main communication link, to transmit again the “data packets” that have not been received the corresponding Ack packets from the packet receiving device 20. The corresponding Ack packets have not been received even though they were transmitted via the smaller-area communication link that was set as the main communication link. In the case of FIG. 9, the transmission instruction unit 105 may instruct the transmission unit of the larger-area communication unit 106 to transmit packets #5 and #6. Alternatively, since the packet in #5 has already been transmitted as one of the sub data packets via the larger-area communication link set as the sub communication link and has already been received by the packet receiving device 20, transmission instruction unit 105 may instruct the transmission unit of the larger-area communication unit 106 to transmit only packet #6.

The lower figure of FIG. 9 shows how the larger-area communication link is switched to the sub-communication link and the smaller-area communication link is switched to the main communication link from the state where the larger-area communication link is set as the main communication link and the smaller-area communication link is set as the sub-communication link. When the receiving unit of the smaller-area communication unit 107 receives the #7 Ack packet, the communication status determination unit 102 determines that the communication status of the smaller-area communication link is good. In response, the main and sub link setting unit 103 sets (in other words, switches the setting) the larger-area communication link as the sub communication link and the smaller-area communication link as the main communication link. After the switchover, the transmission unit of the smaller-area communication unit 107 transmits main data packets that are not policed, and the Ack packets are received because the communication status is good. The transmission unit of the larger-area communication unit 106 is transmitting sub data packets with policing and is receiving Ack packets.

Policing when the larger-area communication link is set as the sub communication link has a lower degree of packet thinning than when the smaller-area communication link is set as the sub communication link. This is because redundant transmission by the larger-area communication link compensates for packet loss due to disconnection of the smaller-area communication link and minimizes retransmission processing. In this case, policing should be done to the extent that the larger-area communication link does not become congested. Thus, when the larger-area communication link is set as the sub communication link, packet loss due to disconnection of the smaller-area communication link can be supplemented by transmitting the sub data packets which were policed in a lower degree via the larger-area communication link. In addition, retransmission processing caused by disconnection of the smaller-area communication link can be minimized.

FIG. 10 is a flowchart showing how to set the main and sub communication links. The main and sub link setting unit 103 determines whether the currently set main communication link is the smaller-area communication link (S161). In a case that the currently set main communication link is the smaller-area communication link, the main and sub link setting unit 103 proceeds to S162, and in a case that the currently set main communication link is not the smaller-area communication link but the larger-area communication link, the main and sub link setting unit 103 proceeds to S163.

In a case that the currently set main communication link is the smaller-area communication link, the main and sub link setting unit 103 checks whether the communication status determination unit 102 has determined that the communication status of the smaller-area communication link is good or poor (S162). In a case that the communication status determination unit 102 determines that the communication status of the smaller-area communication link is good, the main and sub link setting unit 103 maintains the setting where the smaller-area communication link is the main communication link and ends. If the communication status determination unit 102 determines that the communication status of the smaller-area communication link is poor, the main and sub link setting unit 103 sets the larger-area communication link as the main communication link and the smaller-area communication link as the sub communication link (S164). Then, the transmission instruction unit 105 instructs the transmission unit of the larger-area communication unit 106 to retransmit packets that have been transmitted on the smaller-area communication link but for which the Ack packet has not been received on the larger-area communication link (S165).

When the main communication link is not the smaller-area communication link, that is, when the main communication link is the larger-area communication link, the main and sub link setting unit 103 checks whether the communication status determination unit 102 has determined that the communication status of the smaller-area communication link is good or poor (S163). In a case that the communication status determination unit 102 determines that the communication status of the smaller-area communication link is poor, the main and sub link setting unit 103 maintains the larger-area communication link as the main communication link setting. In a case that the communication status determination unit 102 determines that the communication status of the smaller-area communication link is good, the main and sub link setting unit 103 sets the smaller-area communication link as the main communication link and the larger-area communication link as the sub communication link (S166).

### (d) Generation of the Main Data Packets and the Sub Data Packets (Subroutine of S103)

The generation of main data packets and sub data packets is explained using FIG. 11. FIG. 11 shows a flowchart of how main data packets and sub-data packets are generated. The packet generation unit 104 generates a duplicate of the data packets stored in the packet storage 101 (S171). The packet generation unit 104 checks whether the main and sub link setting unit 103 has set the smaller-area communication link as the main communication link (S172). When the main communication link is set as the smaller-area communication link, the packet generation unit 104 proceeds to S172, and when the main communication link is not set as the smaller-area communication link, in other words, when the larger-area communication link is set as the main communication link, the packet generation unit 10 proceeds to S175.

When the smaller-area communication link is set as the main communication link, the packet generation unit 104 generates the main data packets to be transmitted via the smaller-area communication link (S173). Specifically, the packet generation unit 104 generates the main data packets without policing from the data packets and stores the necessary information shown in FIG. 4 in the header of the packets. Next, the packet generation unit 104 generates the sub data packets to be transmitted via the larger-area communication link (S174). Specifically, the packet generation unit 104 generates the sub data packets with policing from the data packets and stores the necessary information shown in FIG. 4 in the header of the packets.

When the larger-area communication link is set as the main communication link, the packet generation unit 104 generates the main data packets to be transmitted via the larger-area communication link (S175). Specifically, the packet generation unit 104 generates the main data packets without policing from the data packets and stores the necessary information shown in FIG. 4 in the header of the packets. Next, the packet generation unit 104 generates the sub data packets to be transmitted via the smaller-area communication link (S176). Specifically, the packet generation unit 104 generates the sub data packets with policing from the data packets and stores the necessary information shown in FIG. 4 in the header of the packets.

### (e) Transmission Instructions for Main Data Packets and Sub Data Packets (Subroutine of S104)

FIG. 12 is a flowchart showing the method of indicating the transmission of main data packets and sub-data packets. The transmission instruction unit 105 checks whether the main and sub link setting unit 103 has set the smaller-area communication link as the main communication link (S181). When the main communication link is set as the smaller-area communication link, the transmission instruction unit 105 proceeds to S182, and when the main communication link is not set as the smaller-area communication link, in other words, when the larger-area communication link is set as the transmission instruction unit 105 proceeds to S184.

When the smaller-area communication link is set as the main communication link, the transmission instruction unit 105 instructs the transmission unit of the smaller-area communication unit 107 to transmit the main data packets (S182). Next, the transmission instruction unit 105 instructs the transmission unit of the larger-area communication unit 106 to transmit the sub data packets (S183).

When the larger-area communication link is set as the main communication link, the transmission instruction unit 105 instructs the transmission unit of the larger-area communication unit 106 to transmit the main data packets (S184). Next, the transmission instruction unit 105 instructs the transmission unit of the smaller-area communication unit 107 to transmit the sub data packets (S183).

### (4) Summary

The above-described embodiment enables redundancy in the data packets to be transmitted by using multiple communication links to transmit main data packets from one side and sub data packets from the other side. As a result, the embodiment enables suppression of packet loss and prevents frequent retransmissions. In addition, the embodiment brings the benefit of the performance of smaller-area communication links as the maximum throughput while maintaining the high connectivity of larger-area communication links. More specifically, the embodiment enables prompt detection that the communication status of the smaller-area communication link has become good and enables faster connection of the smaller-area communication link, since the embodiment transmits the sub-data packets using the smaller-area communication link even if the communication status of the smaller-area communication link is poor. This makes it possible to connect the smaller-area communication link more quickly. In addition, the embodiment enables suppression of packet loss that occurs when the smaller-area communication link becomes poor, since the embodiment transmits the sub-data packets using the larger-area communication link even if the communication status of the smaller-area communication link is good.

### (5) Configuration of the Packet Receiving Device 20

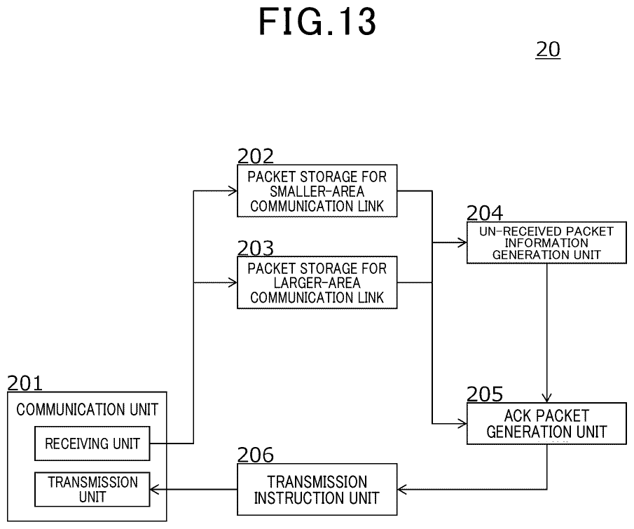

FIG. 13 shows a diagram of the packet receiving devices 20. Packet receiving device 20 includes a communication unit 201, a packet storage 202 for smaller-area communication link, a packet storage 203 for larger-area communication link, an un-received packet information generation unit 204, an Ack packet generation unit 205, and a transmission instruction unit 206.

The receiver of communication unit 201 receives the main data packets or the sub data packets transmitted from packet transmission device 10 via the larger-area communication link or the smaller-area communication link. The communication unit 201 does not have to be a device that directly receives wireless communications via the larger-area or smaller-area communication link, as described in FIG. 1. The transmission unit of communication unit 201 transmits the Ack packets to the packet transmission device 10 based on the instructions of the transmission instruction unit 206 described below.

The packet storage 202 for smaller-area communication links stores the main data packets or the sub data packets transmitted via the smaller-area communication links. The packet receiving device 20 can detect that a packet was transmitted on the smaller-area communication link based on the link type 1 contained by the packet header of the packets in the data packets (shown in FIG. 4).

The packet storage 203 for larger-area communication links stores the main data packets or the sub data packets transmitted via the larger-area communication links. The packet receiving device 20 can detect that a packet was transmitted on the larger-area communication link based on the link type 1 contained by the packet header of the packets in the data packets (shown in FIG. 4).

The un-received packet information generation unit 204 obtains the status of the un-received main data packets and the un-received sub data packets transmitted via the smaller-area communication link and the larger-area communication link. For example, based on the sequence number and link type2 contained by the packet header of the packets in the data packets t (shown in FIG. 4), un-received packet information generation unit 204 determines the packets of which the sequence numbers are smaller than the currently received sequence number and not received by the receiving unit of the communication unit 201 are unreceived packets. It is desirable to exclude packets that have already been received as the sub data packets from the un-received packets. It is possible to minimize packet loss even if packets that have already been received in the sub data packets are excluded from un-received packets, because transmission with redundancy is possible when the sub data packets are transmitted via the larger-area communication link.

The Ack Packet generation unit 205 generates the Ack packets for the main data packets or the sub data packets transmitted via the larger-area communication link or the smaller-area communication link.

The transmission instruction unit 206 instructs the transmission unit of the communication unit 201 to transmit the Ack packet. For example, the transmission instruction unit 206 may instruct the Ack packet to be sent via the communication link on which the received data packets was sent. However, the transmission instruction unit 206 may instruct the Ack packet to be sent on both the larger-area communication link and the smaller-area communication link, regardless of the type of communication link on which the received data packets was sent.

### 2. Other Embodiments

As other embodiments, the packet transmission device 10 or the packet receiving device 20 may have the following configurations and features.

Each of the larger-area communication link or the smaller-area communication link may contain multiple channels instead of a single channel. For example, the larger-area communication link may include eight channels, and the packet transmission device 10 may divide the main data packets into eight separate packets and transmit them. This can increase the actual transmission speed of each communication link.

In addition, FEC (Forward Error Correction) data may be added to the main data packets, or the sub data packets transmitted from the packet transmission device 10. FEC data may be added only to the data packets transmitted via the smaller-area communication links where the communication speed is fast, but the communication area is smaller. This makes it possible to correct or modify the lost main data packets by FEC even if a part of the main data packets is lost, thus eliminating the need for a retransmission request.

The packet transmission device 10 may have the functions of packet receiving device 20. The packet receiving device 20 may also have the functions of the packet transmitting device 10.

In this form, there are two communication links, but there may be three or more communication links. The present invention can be applied if two of them have the same relationship as in this form. The larger-area communication link and the smaller-area communication link may include multiple links, respectively. In this case, the multiple links can be combined to function as the larger-area communication link or the smaller-area communication link.

### 3. Summary

The features of the packet transmission device, packet receiving device, and communication system in each of the embodiments of the present disclosure have been described above.

The terms used in each form are examples and may be replaced with terms that are synonymous or include synonymous functions.

The block diagram used to describe the implementation is a classification and organization of the device configuration by function. The blocks that indicate each function are realized by any combination of hardware or software. Since the block diagrams indicate functions, they can also be understood as disclosing the invention of a method and a program to realize the method.

The functional blocks, which can be understood as processes, flows, and methods, described in each form, may be reordered, as long as there are no restrictions, such as a relationship in which one step uses the results of the other step in the preceding step.

The terms first, second, or N (N is an integer), used in each embodiment and in the claims, are used to distinguish between two or more configurations or methods of the same kind and are not intended to limit order or superiority.

Although each embodiment assumes that the device is installed in a vehicle, the devices of the present disclosure also include dedicated or general-purpose devices other than for vehicles, unless otherwise specifically limited in the claims.

Each of the embodiments is described on the assumption that the device disclosed in each embodiment is mounted on a vehicle, but it may also be assumed to be carried by a pedestrian.

In addition, the following are examples of the forms of devices of the present disclosure. Forms of components include semiconductor devices, semiconductor circuits, electronic circuits, modules, and microcomputers.

Semi-finished products include electronic control units (ECU (Electric Control Unit)), electronic control units, and system boards. The finished product may take the form of a cell phone, smartphone, mobile router, tablet, personal computer (PC), workstation, or server. Others include devices with communication functions, such as video cameras, still cameras, and car navigation systems.

The device may also have additional necessary functions such as antennas and interfaces for communication.

It is contemplated that the apparatus of the present disclosure will be used for the purpose of providing various services. In conjunction with the provision of such services, the devices of the present disclosure may be used, the methods of the present disclosure will be used, and/or the programs of the present disclosure will be executed.

In addition, this disclosure can be realized not only with dedicated hardware having the configuration and functions described in each embodiment, but also with a program for realizing this disclosure, recorded on a recording medium such as a memory or hard disk, and with general-purpose hardware having a dedicated or general-purpose CPU and memory, etc. capable of executing it. This can also be realized as a combination thereof.

The program for the device of this disclosure, which is stored in a non-transitory substantive recording medium (e.g., external storage device (hard disk, USB memory, CD/BD, etc.) or internal storage device (RAM, ROM, etc.)) of dedicated or general-purpose hardware, may be provided via the recording medium or it can also be provided from a server to dedicated or general-purpose hardware via a communication link without a recording medium. This allows the latest functions to be constantly provided through program upgrades.

The packet transmission device of this disclosure is widely applicable as a packet transmission device that uses multiple communication links for communication, such as communication while vehicles are parked and running, communication on ships and aircraft, etc., or communication that handles large amounts of data in fixed facilities.

What is claimed is:

1. A packet transmission device that transmits data packets to a packet receiving device using a first communication link and a second communication link that has a smaller communication area than the first communication link, the device comprising:
a packet storage that stores the data packets;
a communication status determination unit that determines the communication status of the second communication link;
a main and sub link setting unit that sets either one of the first or second communication link as the main communication link and the other as the sub communication link, based on the determination results;
a packet generation unit that generates, from the data packets, main data packets without bandwidth limitation and sub data packets with bandwidth limitation;
a transmission instruction unit that instructs each of a first communication unit and a second communication unit to transmit the main data packets on the main communication link or transmit the sub data packets on the sub communication link;
the first communication unit that transmits the main data packets or the sub data packets via the first communication link based on the instruction from the transmission instruction unit;
the second communication unit that transmits the sub data packets or the main data packets via the second communication link based on the instruction from the transmission instruction unit.

2. The packet transmission device according to claim 1, wherein,
the communication status determination unit determines the communication status of the second communication link based on a reception condition of a confirmation response sent by the packet receiving device that received the main data packets or the sub data packets.

3. The packet transmission device according to claim 2, wherein,
the communication status determination unit determines that the communication status of the second communication link is poor in a case that no confirmation response has been received before a predetermined time elapses after the main data packets are sent over the second communication link.

4. The packet transmission device according to claim 1, wherein,
the bandwidth limitation is policing to thin out the data packets on a packet-by-packet basis.

5. The packet transmission device according to claim 4, wherein,
when the second communication link is the sub communication link, the packet generation unit performs the policing by increasing the degree of thinning compared to when the first communication link is the sub communication link.

6. The packet transmission device according to claim 3, wherein,
when the communication status determination unit determines that the communication status of the second communication link is poor, the transmission instruction unit instructs the first communication unit to transmit the data packets transmitted by the second communication unit for which the corresponding acknowledgement has not been received.

7. The packet transmission device according to claim 3, wherein,
when the communication status determination unit determines that the communication status of the second communication link is poor, the transmission instruction unit instructs the first communication unit to transmit the data packets that have been transmitted by the second communication unit, for which the corresponding confirmation response has not been received and which have not been transmitted by the first communication unit in the past.

8. The packet transmission device according to claim 1, which is mounted to a mobile object.

9. A packet transmission method using a packet transmission device that transmits data packets to a packet receiving device using a first communication link and a second communication link that has a smaller communication area than the first communication link, the method comprising:
determining the communication status of the second communication link;
setting either one of the first or second communication link as the main communication link and the other as the sub communication link, based on the determination results;
generating main data packets without bandwidth limitation and sub data packets with bandwidth limitation from the data packets stored in the packet storage;
generating instructions to transmit the main data packets on the main communication link and the sub data packets on the sub communication link;
transmitting the main data packets or the sub data packets via the first communication link based on the instructions;
transmitting the sub data packets or the main data packets via the second communication link based on the instructions.

10. A computer-readable non-transitory storage medium storing a packet transmission program, the program causing a packet transmitting device that transmits data packets to a packet receiving device using a first communication link and a second communication link that has a smaller communication area than the first communication link to:
determine the communication status of the second communication link;
set either one of the first or second communication link as the main communication link and the other as the sub communication link, based on the determination results;
generate main data packets without bandwidth limitation and sub data packets with bandwidth limitation from the data packets stored in the packet storage;
generate instructions to transmit the main data packets on the main communication link and the sub data packets on the sub communication link;
transmit the main data packets or the sub data packets via the first communication link based on the instructions;
transmit the sub data packets or the main data packets via the second communication link based on the instructions.
